(19) United States
(12) Patent Application Publication
(10) Pub. No.: US 2009/0299918 A1
(43) Pub. Date: Dec. 3, 2009

(54) Wireless delivery of power to a mobile powered device

(75) Inventors: Nigel P. Cook, El Cajon, CA (US); David F. Allred, Rancho Santa Fe, CA (US)

Correspondence Address: Law Office of Scott C Harris Inc, PO Box 1389, Rancho Santa Fe, CA, 92067, US

(73) Assignee: NIGELPOWER, LLC, San Diego, CA (US)

(21) Appl. No.: 12/128,572

(22) Filed: May 28, 2008

(51) Int. Cl. G06Q 30/00

(52) U.S. Cl. 705/412

(57) ABSTRACT

A system that automatically detects the presence of an automobile that can operate wirelessly to recharge the battery therein, and detects account information associated with that automobile. When the account information is properly detected, the amount of power delivered is metered, and thereafter the power used by a user is Bill to the user at a markup based on that distributed by the distribution company.

### BACKGROUND

Wireless delivery of power may be used to provide power to a load. For example, U.S. patent application Ser. No. 12/018,069, filed Jan. 22, 2008, entitled “Wireless Apparatus and Methods”, the disclosure of which is herewith incorporated by reference, describe wireless transfer of power to a load. This may be done by forming a magnetic field and receiving a magnetic field in a resonant antenna that is resonant with at least one characteristic of a magnetic field. The power transmission may also be done inductively. The magnetic delivery of power, however, has the advantage of being capable of delivering power over a longer distance.

### SUMMARY

The present application describes wireless delivery of power to a mobile powered device such as an automobile. An embodiment describes how power can be delivered to the automobile in a number of different locations.

### BRIEF DESCRIPTION OF THE DRAWINGS

These and other aspects will now be described in detail with reference to the accompanying drawings, wherein:

FIG. 1 shows an overall block diagram of a system for delivering power wirelessly to a load; and

FIG. 2 illustrates a flowchart of operation that may be carried out in controller 180 or in hardware that is distributed at various locations throughout the network.

### DETAILED DESCRIPTION

Delivery of electric power to automobiles may become more prevalent as electrically powered automobiles enter and occupy a more significant portion of the market. For example, as of the time of writing of this document, there are many different forms of hybrid automobiles which operate based both on internal combustion engines, and also on stored charge in a battery. There are fewer forms of electric automobiles such as plug-in hybrids or plug-in electric vehicles.

Commercial success of such a vehicle would require that either the vehicle have a sufficient mileage range to make an entire round-trip without recharging, or that the user recharge the vehicle at some intermediate point. Currently, there are vehicle charging stations mostly associated with public areas, for example airports and public parking places. This is done in many ways as a public service to allow or encourage more people to use electric automobiles. However, this is not a long-term practical solution.

The inventors also recognize that it may be desirable to wirelessly deliver power to an electric powered mobile device, such as an automobile.

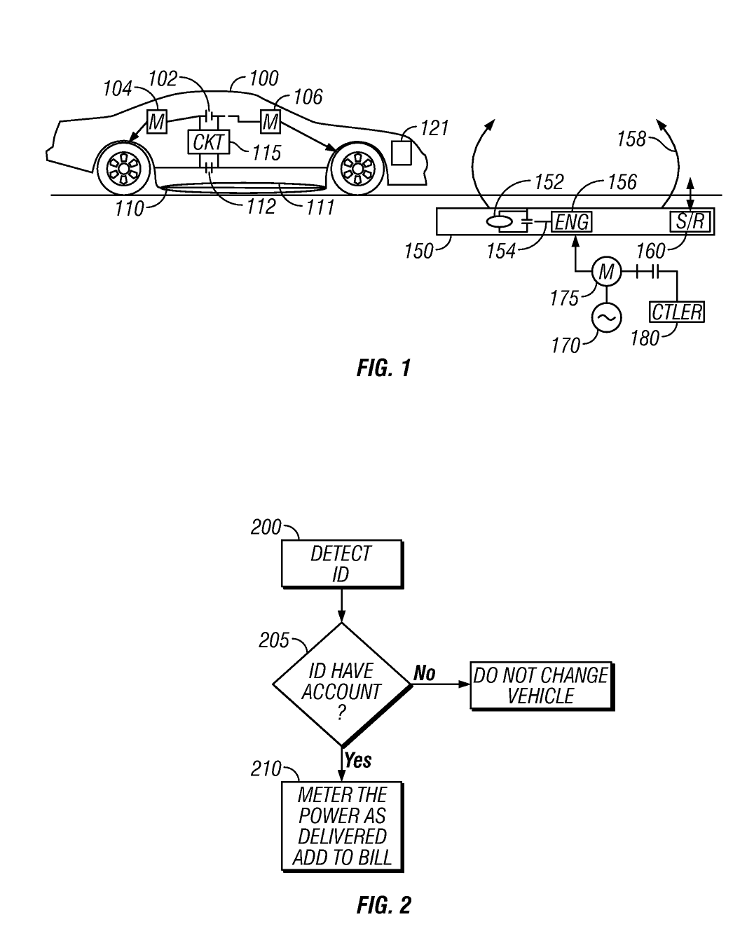

FIG. 1 illustrates a block diagram of a system according to the present application. An electrically powered automobile includes at least one battery 102 which may operate at least one electronic mobile system of the automobile. For example, in one embodiment, the battery 102 may be the primary power source of the automobile. In other embodiments, the battery may be a partial driver, such as a hybrid vehicle which can operate based on electric power from the battery, or from electromotive force such as gas power, or both.

The battery 102 is shown driving an electric motor 104, 106 which may drive vehicle wheels, for example.

In the embodiment, the automobile also includes at least one magnetic resonant antenna shown as 110 formed from an inductive loop 111 in parallel with a capacitor 112. This forms an LC circuit with a relatively high Q, for example a Q that is higher than 1000. In the embodiment, when the antenna 110 comes into range of an appropriate transmitter, it receives a magnetic signal from that transmitter, and the receiving circuit 115 converts that power into output current. That power can be used for directly driving the motors 104, 106, but more preferably is used for charging the battery 102.

In the embodiment, the battery is automatically charged whenever the antenna 112 comes into range of a wireless charging circuit of appropriate type, e.g. the right frequency. A number of different places, such as parking lots, and more specifically public places, may have appropriate chargers such as 150 in specified locations. In the embodiment, the charger 150 may be located within the ground near a parking space.

Charger 150 may include a coil 152, a capacitor 154, and a charging circuit 156 that produces signal of appropriate frequency for magnetic transmission. Charger 150 may produce a magnetic field shown generally as 158. Whenever an appropriate vehicle comes into range of the magnetic field 158, it may receive power from that magnetic field, and hence be charged thereby.

The charger 150 also includes an information detecting part. This may be a send and receive portion 160 that wirelessly detects a unique identifier indicative of the vehicle 100. In one embodiment, the vehicle 100 may include an RFID device 121 that uniquely identifies the vehicle. Information from the RFID device may be detected by the send and receive device 160. Another embodiment may use a camera or scanner to detect some written item on the automobile, e.g., the license plate or serial number or barcode on the automobile.

In operation, the vehicle charging operation may operate as follows. FIG. 2 illustrates a flow chart in which step 200 detects the identification of the vehicle. At 205, a detection is made of whether that detected identification has an account associated therewith. This is sent to a controller that has the ability to detect whether there is an existing account, e.g. controller 180. This may be at a remote location that stores the vehicle identification information. If the controller verifies the ID as being one that is associated with an account at 205, charging is enabled. This causes power to be delivered from the AC Main, through a meter 175, to the charging device 150. The meter 175 is an integrating meter which automatically keeps track of exactly how much power is delivered to the charging antenna 150. The amount of power delivered is monitored by the controller as an amount of power that will be added to the bill.

A premium over utility costs may also be added to the bill. In essence, this system is reselling power from the electricity manufacturer, to any vehicle with an appropriate account that comes into range of the antenna.

Another embodiment may recognize that the detection of an ID could be cloned, and use encryption techniques to verify the ID. For example, one embodiment might use a real-time token type system. The vehicle has a real time clock which is used to display time. The time is encrypted by the vehicle's private encryption key. The controller has a decryption key that can decrypt the encrypted message. The controller thereby 1) checks whether the value can be decrypted, and 2) checks whether the time is correct (to avoid reuse of a previously-sent message).

This cryptographically determines whether the power delivery is accurate by the controller 180. Power is allowed to be dispensed only if an encrypted value properly agrees with the proper encryption code and proper token time.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of power transfer can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer.

What is claimed is:

1. A method comprising:
wirelessly supplying power to a vehicle that operates from electric power; and
providing billing data to an owner of the vehicle based on an amount of power that has been wirelessly supplied.

2. A method as in claim 1, wherein said supplying comprises detecting identification information about the vehicle, and metering an amount of power that is supplied to the vehicle.

3. A method as in claim 2, wherein said supplying further comprises determining whether said identification information is associated with an existing account, and wirelessly supplying said power only once the account is determined to be associated with said account.

4. A method as in claim 1, further comprising identifying a user of an automobile prior to wirelessly supplying said power.

5. A method as in claim 4, wherein said identifying comprises carrying out a cryptographic operation to identify the user.

6. A method as in claim 5, wherein said cryptographic operation comprises verifying that the vehicle is associated with a registered account for billing data.

6. A method as in claim 1, wherein said wirelessly supplying power comprises applying power using a magnetically resonant antenna which includes an inductor and a capacitor, and has a Q value greater than 1000.

7. A method as in claim 4 wherein said identifying the user comprises wirelessly identifying the user.

8. An apparatus comprising:
a wireless transmitter, located adjacent a vehicle parking space, and supplying magnetically resonant power via said wireless transmitter; and
a billing computer, receiving billing information for a specific account associated with a specific vehicle, based on an amount of power that has been wirelessly supplied.

9. An apparatus as in claim 8, further comprising a billing account detector that detects identification information about the vehicle, and meters an amount of power that is supplied to the vehicle.

10. An apparatus as in claim 9, wherein said billing computer determines whether said identification information is associated with an existing account, and enables said wireless transmitter to supply said power only once the account is determined to be associated with said existing account.

11. An apparatus as in claim 10, wherein said billing account detector includes a cryptographic processor that verifies cryptographic information within said identification information, and said billing computer determines whether said identification information is associated with an existing account, and enables said wireless transmitter to supply said power only once the account is determined to be associated with said existing account.

12. An apparatus as in claim 11, wherein said cryptographic operation comprises verifying that the vehicle is associated with a registered account for billing data.

13. An apparatus as in claim 8, wherein said wireless transmitter supplies power using a magnetically resonant antenna which includes an inductor and a capacitor, and has a Q value greater than 1000.

14. An apparatus as in claim 9 wherein said billing account detector wirelessly identifies the user.

15. A method comprising:
purchasing power from a power utility company;
wirelessly supplying the power to a vehicle that operates from electric power; and
providing billing data to an owner of the vehicle based on an amount of power that has been wirelessly supplied, where the billing data includes a profit over the power that has been purchased from the power utility company.

16. A method as in claim 15, wherein said supplying comprises detecting identification information about the vehicle, and metering an amount of power that is supplied to the vehicle.

17. A method as in claim 16, wherein said supplying further comprises determining whether said identification information is associated with an existing account, and wirelessly supplying said power only once the account is determined to be associated with said account.
